(19) United States
(12) Patent Application Publication
(10) Pub. No.: US 2026/0265025 A1
(43) Pub. Date: Sep. 10, 2026

(54) BASE FRAME OF A MOBILE HYDRAULIC CRANE

(71) Applicant: TAJFUN LIV, PROIZVODNJA IN RAZVOJ D.O.O., Postojna (SI)

(72) Inventors: Iztok SPAN, Ljubljana (SI); Branko GRIL, Prestranek (SI); Tine NARED, Rakek (SI)

(21) Appl. No.: 18/880,175

(22) PCT Filed: Jun. 6, 2023
(86) PCT No.: PCT/SI2023/000006

§ 371 Date: Dec. 30, 2024

(30) Foreign Application Priority Data
Jun. 30, 2022 (SI) P-202200101

(51) Int. Cl. B66C 23/26; B66C 23/78

(52) U.S. Cl. CPC B66C 23/26; B66C 23/78

(57) ABSTRACT

The purpose of the present disclosure is to create a base frame of a mobile hydraulic crane that can enable reliable operation of the crane by a smooth transmission of loadings from the crane onto a vehicle chassis. The base frame of the present disclosure can be easily and precisely manufactured in mass production. Moreover, the base frame may be mounted or placed onto the crane of different vehicle types, improving flexibility. The base frame of the present disclosure comprises a central portion adapted for receiving a crane column (91), a primary beam, and a secondary beam. Said central portion, primary beam and secondary beam are manufactured separately then formed into an independent uniform part. The central portion is detachably connected by means of a screw joint to said primary beam on a first end and to said secondary beam on a second end.

### CROSS-REFERENCE TO RELATED APPLICATIONS

This application is a United States national phase application of co-pending International Patent Application No. PCT/SI 2023/000006, filed on 6 Jun. 2023, which claims the benefit of Slovenia Patent Application No. P-202200101 filed 30 Jun. 2022, both of which are hereby incorporated by reference in their entirety.

### BACKGROUND

The present disclosure refers to a base frame of a mobile hydraulic crane, and, in particular, a crane, which is either during transporting in its folded inactive position or during its operation i.e. in its operational position, attached onto a chassis of a motor vehicle. Such crane is generally powered by a hydraulic driving means, which is connectable with a hydraulic circuit powered by a vehicle engine.

According to the International Patent Classification (IPC^{2022.1}) such disclosure may belong to transporting and hoisting, and can be in the area of foldable cranes found in the class B 66 C 23/42.

The aim of the present disclosure is to create a base frame of a mobile hydraulic crane, which should enable reliable operation of the crane and regular transmission of forces from the crane to a vehicle chassis, and which should be, at least when compared with base frames known from the state of the art, essentially simplified in the view of precisely manufacturing thereof in a mass production, and which should moreover also enable modifications and adaptations to various requirements either by mounting of a crane onto a certain vehicle or also by mounting of a crane to various vehicles of different types.

The ordinary position of such crane during its regular use on a vehicle, which the crane should be set at at least during its operation (e.g., when manipulating a load), should be resting on the ground. In this position, the crane should be suitably stabilized and secured against inclinations, sinking, overturning and also against undesired movements in the horizontal plane. For the purposes of this application the expression “horizontal direction” or “horizontal plane” should be understood as a direction or a plane, which in relationship to a position of a crane extends substantially in the ground plane, or in parallel with said ground plane. Similarly, the expression “vertical direction” or “vertical plane” means a direction or a plane, which in relationship to a position of a crane extends perpendicularly to the ground plane.

The expression “base frame” of a mobile hydraulic crane annotates one of the essential construction components of the crane as such, by which the crane is attachable onto a chassis of a corresponding vehicle. Thus, the mobile hydraulic crane comprises a base frame within which a crane column is mounted rotatably around vertical geometric axis. Thus, the column is actually a cantilever beam, which should be reliably embedded within said base frame in order to assure proper loading capacity of the crane. A primary crane arm is pivotal about a horizontal geometric axis attached to said column in the area of a free terminal portion thereof, while on the free opposite terminal area of said primary arm, an optionally telescopic secondary arm is also pivotal about a horizontal geometric axis attached to said primary arm. A grabber is, either directly or indirectly via a suitable rotating unit, pivotally attached to the free terminal area of said secondary crane arm. Said primary arm is supported on said column by means of a hydraulic cylinder, which is on the one hand pivotally connected with a column and on the other hand pivotally connected with said primary arm. Similarly, said secondary arm is supported on said primary arm by means of a hydraulic cylinder, which is on the one hand pivotally connected with the primary arm and on the other hand also pivotally connected with the secondary arm. Said hydraulic cylinders are, together with all associated control components, integrated into a hydraulic circuit. The hydraulic circuit is hydraulically connectable to a hydraulic system on a vehicle on which the crane is mounted.

As mentioned above, said column is rotatably around the vertical geometric axis mounted to said base frame. Thus, a substantially cylindrical passage is available in the central portion of the base frame, into which a substantially cylindrical section of said column is insertable. Two ball bearings or roller bearings are usually inserted between the inner wall of said passage in the base frame and the surface of said beam section, and are suitably spaced apart from each other in a vertical direction. This approach may enable reliable embedding of said cantilevered column and also rotating thereof around said vertical geometric axis. In order to rotate said column around said vertical geometric axis, the column is, either on its circumference or in the area of its front surface, furnished with a cylindrical gear, which is located in a horizontal plane and is adapted for cooperation with a pair of gear racks. The pair of gear racks are arranged parallel to each other and are synchronously displaceable in a horizontal plane and in opposite directions relatively to each other. Each of said gear racks is displaceable by means of a hydraulic cylinder, so that two hydraulic cylinders are also mounted in the area of said base frame. The hydraulic cylinders extend parallel to each other and operate in opposite directions with regard to each other. Thus, said base frame is furnished with two passages, which extend parallel to each other and are both arranged in the same horizontal plane. The piston rods of said hydraulic cylinders are placed, together with said gear racks, into the two passages. The gear racks are attached to each of the piston rods of said hydraulic cylinders and each per se cooperate with the gear on the crane column.

Said base frame is therefore an essential component of the crane both in view of reliable embedding of the column and also in view of enabling rotation of the column around the vertical geometric axis. However, due to positioning and attaching of said base frame with its central area onto a vehicle chassis, said central portion of the base frame is on the one side, relatively to said central passage, equipped with a primary beam, and on a diametrically opposite side also with a secondary beam. In most cases, a vehicle chassis is available for mounting a previously discussed crane. The vehicle chassis normally consists of two bearing beams, which are parallel to each other and are arranged in a horizontal plane located at certain distance above the ground. Each of said bearing beams is an I, U, C or similar profile in its transversal cross-section, or is eventually tubular, i.e. formed as a square or rectangular tube, or even as a box. Nevertheless, for the purpose of mounting such crane onto a chassis, it is usually sufficient if each of said bearing beams is on the side facing away from the ground that furnished with a sufficiently large flat and smooth horizontal surface. Both horizontal surfaces on said bearing beams are usually also located in the same plane.

Said primary beam on the base frame may also be known to those skilled in the art as “a bridge”, while the secondary beam is sometimes named as a guiding or swiveling bridge.

Said primary beam is a sufficiently rigid linear bearing beam that is both suitable for resting on said flat surface of each of the bearing beams of a vehicle chassis and tubular. Since the primary beam is placed onto the vehicle chassis transversally relative to its bearing beams, said tubular concept of the primary beam allows a pair of supporting legs, which are intended for stabilization of the crane during operation thereof, to be inserted inside the primary beam. Each supporting leg comprises a horizontal beam insertable into said tubular primary beam and a vertically oriented hydraulic telescopic supporting leg. Said horizontal beam is, during transporting of the crane, located inside of the primary beam of the base frame and is secured against undesired extraction. However, prior to operation of the crane, the horizontal beam is usually extended up to certain extent and secured again against any further movement. Thus, the associated telescopic leg is extended to rest on the ground, thereby stabilizing the crane by supporting the crane on the ground in at least two additional points. These additional points are located at a required distance outside of the bottom silhouette of the vehicle. In addition, said primary beam must also enable reliable attachment of the base frame onto the associated vehicle chassis. Thus, the primary beam is furnished with at least two attachment seats, which are each per se adapted for establishment of a reliable interconnection between the base frame and each corresponding bearing beam of the vehicle chassis. In practice, one should bear in mind that such a crane is an independent commercial product with pre-determined performances, which can be purchased and then mounted onto one of numerous different vehicles. Crane manufacturers usually offer for sale several types of cranes, which differ from one to another with regard to the loading capacity, various concepts of folding the arms, details related to location of mounting of the crane onto each vehicle, or to location of a crane cabin with an operator cockpit, or the like. Thus, said attachment seats on the primary beam should therefore also allow certain flexibility to allow for mounting a certain crane on different vehicles produced by various manufacturers, and generally also of dismounting a certain crane from the one vehicle in order to mount it onto another vehicle, which happens by replacement of a vehicle, e.g. due to damages, wearing, or sale, or also by replacement of a crane with another one, e.g. due to modernization.

The secondary beam, which is with respect to said central passage located diametrically opposite side of the base frame as the primary beam, is intended merely for resting of the base frame on to a vehicle chassis and for establishing a reliable interconnection between the base frame and at least one of the bearing beams of the vehicle chassis by means of screws. In combination with previously discussed concept of the primary beam, these measures should altogether be in principle sufficient for establishing a reliable interconnection between the crane and the vehicle chassis. To this aim, the secondary beam is furnished with at least one attachment seat, which is on said secondary beam arranged in the area above the associated bearing beam of the chassis and which should be connected by screws. And as mentioned in reference to the primary beam, the secondary beam should allow the crane to be mountable on different vehicles of various manufacturers.

Several embodiments of secondary beams are known in the art. In a rigid version of a base frame, the secondary beam is made integrally with the central portion and is usually furnished with two attaching seats, which are spaced apart from each other. Another embodiment of a pivotally arranged secondary beam is also known, in which the central area of said secondary beam is attached to the central portion of the base frame such that it is a suitable pivot point for pivoting about a horizontal geometric axis. Such secondary beam is, either at a single attachment point or at two attachment points located on both sides of said pivot point, interconnectable via screws with corresponding bearing beams of the vehicle chassis. In such case, the secondary beam is, during operation of the crane, allowed to pivot in one or another direction around said pivot point. In this way, the position of the secondary beam is easily adjusted to deformations within the chassis, which may occur during operation of the crane. This is sometimes very important because the transmission of dynamic forces from the crane to the vehicle that cause deformations within the chassis may then occur gradually and smoothly in correlation with forces which are transferred from the crane. Thus, the impact of dynamic forces is reduced. Moreover, the interaction between the crane and the vehicle chassis in view of jointly withstanding forces and deformations can be much more efficient. Additionally, the risk of damages either on the vehicle or on the crane due to long term dynamic stresses can be correspondingly reduced.

A mobile hydraulic crane, which is disclosed e.g. in SI 26015 A or WO 2021/251901 A1, comprises a base frame intended for attachment of the crane onto a vehicle chassis.

A base frame as such is disclosed e.g. in SI 25450 A1 or WO 2018/222143 A1 and comprises a central portion that is adapted to receive and embed a crane column and that is also simultaneously adapted to rotate the crane column around the vertical geometric axis while a primary beam and a secondary beam are attached to said central portion on diametrically opposite sides thereof and are arranged substantially parallel to each other. The primary beam is tubular and is therefore suitable for embedding of supporting legs therein, and is moreover furnished with suitably spaced attaching seats. The secondary beam, which is also furnished with a pair of suitably spaced attaching seats, is rigidly connected with said central area. In this particular version of the base frame, said central portion is furnished with a substantially cylindrical passage for receiving a crane column and together with said tubular primary beam and said secondary beam form an integral (i.e. uniform) part. In view of its geometry and dimensions, this integral part is an extremely bulky and complex component. This part is normally manufactured from tubes and a plurality of other parts of various shape and dimensions, which are then assembled and welded with each other. These must be carefully and precisely manufactured prior to assembling and welding them together. Production of such a complex component requires a mass of material, including meaningful losses thereof, a lot of welding as well as subsequent thermal treatment and finalization on tool machines. In this, even the stage of preparing all required semi-products from tubes or plates requires time and energy consumption. Assembling and welding of numerous parts after that results in a rough approximation of a final product, but is not yet finalized at that stage. In addition, such welded complex component may, due to welding and residual tensions, be pretty deformed. Tensions within the interior may gradually be released over time, which may result in changes of shape and dimensions of the complex component over time and even during use of the crane. This problem may be, at least to a certain extent, reduced with a proper thermal treatment, but not completely and not forever. Subsequent mechanical machining operations are also a huge problem, but are unavoidable, if a required functionality is added to said rough and complex welded part. For example, the required functionality may be resting onto a flat surface (e.g. on the bearing members of a vehicle chassis), surmounting of roller bearings and a crane column, surmounting of a gear and hydraulic cylinders with piston rods and gear racks for rotating said column, or the like. Performing mechanical machining operations on such a complex part is extremely complicated and may require heavy and precious tool machines, which require financial investments. Moreover, the expectations of crane users may also be different based on their practical needs and circumstances, which may include mounting of a crane to different vehicles of various manufacturers. As mentioned above, there are generally several types of cranes available, which differ from each other with regard to capacity or also to constructional concept, e.g. in a way of folding crane arms, or the like. In certain cranes types, the central portion is positioned exactly in the middle of the primary beam, while, in other crane types, the central portion may be offset in one or direction or the other along the primary beam while simultaneously retaining complete functionality of the secondary beam. This means that in parallel to said complexity of manufacturing one must also bear in mind different variations of the base frame, which need to be assembled, welded and then machined in a proper way, and each type of a base frame should preferably already be at disposal, if the user decides to mount a certain crane on a desired type of a vehicle.

Consequently, in some cases, integral base frames may be, on the one hand, substantially able to fulfill all requirements of its functionality, but, on the other hand connected with huge problems the manufacture thereof the ability to incorporate required modifications resulting from actual needs and requirements for mounting different types of cranes onto various vehicles.

Similar integrally manufactured base frames of hydraulic mobile cranes are also disclosed in several other prior art documents, e.g. in EP 2 947 037 A1 and EP 2 947 037 A1 (EPSILON Kran GmbH) as well as in WO 2018/108523 A1 (CARGOTEC PATENTER AB).

The present disclosure refers to a base frame of a mobile hydraulic crane, said base frame generally comprising
a central portion having a cylindrical central passage, which is configured to receive a cylindrical section of the crane, where a central geometric axis of the central portion extends in a vertical direction, where the central portion includes two through passages that are spaced apart from each other and extend in a vertical plane, wherein the through passages are each configured to receive a hydraulic cylinder having piston roads and gear racks suitable for cooperation with a gear, the hydraulic cylinders are configured to rotate the column of said crane within said central passage;
a tubular primary beam arranged on a first side of said central portion and extending substantially parallel to said through passages disposed within the central portion, where the primary beam comprises: terminal portions comprising apertures that are configured to receive supporting legs; a horizontal bottom surface that is configured to rest on bearing beams of a vehicle chassis, wherein an area of said base frame of the crane is mountable to the bearing beams; at least two attaching seats located on a vertical lateral surface of the primary beam, where the vertical lateral surface is faced away from said central portion, and where the at least two attaching seats are arranged in pre-determined areas, that the primary beam is intended to be rest onto said bearing beams of said vehicle chassis;
a secondary beam arranged on an opposite side of the central portion from said primary beam and comprising: a horizontal bottom surface configured to rest on the bearing beams of the vehicle chassis to which the area of said base frame of the crane is mountable; at least one attaching seat located on a vertical lateral surface of the secondary beam, wherein the vertical lateral surface of the secondary beam is faced away from said central portion, and is arranged in a pre-determined area in which the secondary beam is planned to be rest onto at least one of said bearing beams of the vehicle chassis.

When taking into consideration the previously mentioned technical problem, the present disclosure proposes that
said central portion of the base frame is an independent uniform part, with said cylindrical passage for receiving of the column of the crane and said horizontal passages for receiving of said hydraulic cylinders for controlled rotation of the column around the vertical geometric axis;
said primary beam is an independent and uniform tubular part, with the terminal areas furnished with apertures for receiving of supporting legs, a horizontal bottom surface, which is configured to rest on bearing beams of the vehicle chassis, and at least two attaching seats, which are arranged on the vertical surface at pre-determined locations corresponding to said bearing members of the vehicle chassis;
said secondary beam is an independent and uniform part, with the horizontal bottom surface, which is configured to rest on said bearing members of the vehicle chassis and the at least one attaching seat, which is arranged on its vertical lateral surface, which is faced away from the central portion, and at pre-determined location(s) corresponding to said bearing members of the vehicle chassis;
wherein said central portion of the base frame is disposed outside of a circumference of said cylindrical central passage and outside of said throughout passages, wherein the central portion is disposed on one side of said through passages, wherein the central portion is form-locking assembled with said primary beam by a screw joint that firmly but detachably connects the central portion with said primary beam, wherein the primary beam is oriented with the vertical surface with said attaching seats faced away from the central portion, where, on an opposite side of said through passages, said central portion is form-locking assembled with said secondary beam by a screw joint that firmly but detachably connects the central portion with said secondary beam, wherein said primary beam and secondary beam are arranged parallel to each other and with the bottom surfaces of the primary beam and the secondary beam located substantially within the same plane.

In some embodiments of the present disclosure, said secondary beam is form-locking assembled with said central portion by a screw joint that firmly but detachably connects the secondary beam to the central portion. Moreover, the secondary beam is pivotable about a horizontal axis that extends perpendicularly with respect to each geometric axis of each throughout passages in the central portion.

In some embodiments, said central portion of the base frame comprises a substantially tubular area protruding in vertical direction and comprising said central passage and a base area through which said through passages extend parallel to each other. Said base area comprises two pairs of protrusions that are spaced apart from each other on each side of said through passages. The two pairs of protrusions extend in horizontal direction away from said through passages and substantially perpendicularly with respect to them. Each of said protrusions includes a vertical throughout bore.

The height of all protrusions in the vertical dimension along the geometric axis is equal. Said through bores are arranged symmetrically with respect to said vertical geometric axis of said central passage. Moreover, said through bores are located in corners of a virtual square where the sides of the virtual square are arranged parallel or perpendicular with respect to said through passages. It may be desirable for an indentation to be located in an area between each pair of protrusions. The indentation is formed by two flat vertical inner surfaces of two neighboring protrusions on the same side of said through passages that face towards each other and a vertical intermediate surface on said base area of the central portion, to which said inner surfaces of the corresponding protrusions are perpendicular.

Furthermore, said primary beam comprises a flat attaching tongue on a bottom horizontal surface between said attaching seats and a further flat attaching tongue on its top horizontal surface between said attaching seats. Said attaching tongues each extend in a horizontal direction away from said attaching seats. Moreover, said attaching tongues extend substantially parallel to each other and are spaced apart from each other at a distance corresponding to said height (i.e. said vertical dimension) of said protrusions on the central portion. Each of said attaching tongues comprises two through bores, which are spaced apart from each other in such a way that the bores on the one attaching tongue are arranged coaxially with the bores on the further attaching tongue. Moreover, the distance between the bores of the attaching tongues corresponds to a distance between the through bores on the said protrusions on the central portion on the same side of said through passages.

In some embodiments, a protrusion is formed on said primary beam between said attaching tongues, where said protrusion faces away from said attaching seats. The protrusion is positively and tightly insertable into one of said indentations between two neighboring protrusions of the base area on the same side with respect to said through passages.

In some embodiments, said secondary beam comprises a flat attaching tongue on a bottom horizontal surface and a further flat attaching tongue on a top horizontal surface. Said attaching tongues are both directed away from said attaching seats in a horizontal direction. Moreover, said attaching tongues are both oriented in the same direction and extend substantially parallel to each other. The attaching tongues are spaced apart from each other at a distance corresponding to said height (i.e. said vertical dimension) of said protrusions on the central portion. Still further, each of said attaching tongues comprises two through bores spaced apart from each other such that the bores on the attaching tongue are arranged coaxially with the bores on the further attaching tongue. The distance between the attaching tongues corresponds to a distance between the throughout bores on said protrusions on the central portion on the same side of said through passages.

In some embodiments, a protrusion is also formed on said secondary beam between the attaching tongues. The protrusion is positively and tightly insertable into one of said indentations between two neighboring protrusions of the base area on the same side with respect to said through passages.

In some embodiments in which the secondary beam is pivotably connected to the central portion, said secondary beam comprises an attaching portion and a resting portion. Said attaching portion comprises said attaching tongues and said protrusion on one side and a pivot pin disposed on a vertical surface of said attaching portion in an area between said attaching tongues on a second, opposite side of said secondary beam and protrudes in a direction opposite to said attaching tongues. Said resting portion comprises a throughout bore located such that it is attachable to said pivot pin such that it is pivotably connected to said attaching portion. The resting portion also comprises at least one attaching seat on each of a vertical lateral surface and a bottom surface, where the at least one attaching seats are adapted for placement onto at least one member of a vehicle chassis.

Said screw joint between the central portion and the primary beam is formed such that: the protrusion of the primary beam is inserted into said indentation on the base area of the central portion, the two protrusions on said base area of the central portion are located between the top and the bottom attaching tongues of the primary beam, screws are inserted through said vertical throughout bores on protrusions on the same side of said through passages and simultaneously through said bores in said attaching tongues, and nuts and washers corresponding to the screws are coupled thereto.

Said screw joint between the central portion and the secondary beam is formed such that: the protrusion of the secondary beam is inserted into said indentation on the base area of the central portion, the two protrusions on said base area of the central portion are located between the top and the bottom attaching tongues of the secondary beam, screws are inserted through said vertical throughout bores on protrusions on the same side of said through passages and simultaneously also through said bores in said attaching tongues, and nuts and washers corresponding to the screws are coupled thereto.

In some embodiments, said attaching tongues are arranged in a central area of the primary beam when observed along the primary beam. In other embodiments, said attaching tongues are arranged outside of the central area of the primary beam when observed along the primary beam, so that the central portion of the base frame is then arranged closer to the one or another terminal area of the primary beam.

In some embodiments, said primary beam is an uniform part, formed of metallic semi-products that are welded together. In particular, the uniform part that is formed of components that are initially separately cutout from a metallic plate and properly shaped before being welded together.

In some embodiments comprising a pivotal secondary beam, said resting portion of the secondary beam, which is furnished with at least one attaching seat and a vertical lateral surface and which is pivotally connectable with said attaching portion, is a uniform part that is formed of metallic semi-products that are welded together. In particular, the uniform part may be formed of components that are initially separately cutout from a metallic plate and properly shaped before being welded together.

In some embodiments, the central portion is a uniform part that is formed of metallic semi-products that are welded together. In particular, the uniform part is formed of at least one tubular metallic component and other components that are initially separately cutout from a metallic plate and properly shaped before being welded together and also with said tubular metallic components. In alternative embodiments of the base frame according to the present disclosure, said central portion can also be a mechanically machined part comprising cast metal or a mechanically machined part that is pre-formed by forging.

In addition to anchoring to a column belonging to a simple crane, said central portion of the base frame can be used without the presence of the primary and secondary beam. In such cases, said central portion is connectable in via the vertical through bores to a rigid bearing plate by screws. The bearing plate comprises through bores, which are arranged to correspond to and are coaxially aligned with said vertical through bores on the central portion when the central portion and said bearing plate are assembled. In some embodiments, said bearing plate can either be an integral part of a motor vehicle chassis or an integral part of a trailer.

### BRIEF DESCRIPTION OF THE DRAWINGS

The present disclosure will be described in more detail on the basis of embodiments and in relationship with the attached drawings, wherein

FIG. 1 is a mobile hydraulic crane together with its base frame, schematically presented in top view and in its expanded operational position, in which it is mounted on a vehicle, according to some embodiments of the present disclosure.

FIG. 2 is a mobile hydraulic crane as shown in FIG. 1 together with its base frame and schematically presented in top view in its folded position ready for transporting, and including a schematic presentation of mounting said crane onto a vehicle, according to some embodiments of the present disclosure.

FIG. 3 is an isometric view of a base frame known in the state of the art and is directly applicable in combination with a crane according to FIGS. 1 and 2, according to some embodiments of the present disclosure.

FIG. 4 is a first embodiment of a base frame with a centrally arranged central portion, as known in the state of the art, in isometric view, according to some embodiments of the present disclosure.

FIG. 5 is a second embodiment of a base frame with its central portion arranged closely to its first terminal area, as known in the state of the art, in isometric view, according to some embodiments of the present disclosure.

FIG. 6 is a third embodiment of a base frame with its central portion arranged closely to its second terminal area, as known in the state of the art, in isometric view, according to some embodiments of the present disclosure.

FIG. 7 is an embodiment of a base frame according to the present disclosure, that is furnished with a rigid secondary beam, in isometric explosion view, according to some embodiments of the present disclosure.

FIG. 8 is an assembled base frame according to FIG. 7 in isometric view, according to some embodiments of the present disclosure.

FIG. 9 is a further embodiment of the base frame according to the present disclosure with a pivotal secondary beam, in isometric explosion view, according to some embodiments of the present disclosure.

FIG. 10 is an assembled base frame according to FIG. 9 in isometric view, according to some embodiments of the present disclosure.

FIG. 11 is a separately and in isometric view presented central portion of the base frame according to the present disclosure, which is in assembled state also presented in FIGS. 7-10 , according to some embodiments of the present disclosure.

FIG. 12 is explosion presentation of the base frame with a centrally arranged central portion according to the present disclosure, in isometric view, according to some embodiments of the present disclosure.

FIG. 13 is explosion presentation of the base frame with its central portion arranged closely to its first terminal area according to the present disclosure, according to some embodiments of the present disclosure.

FIG. 14 is explosion presentation of the base frame with its central portion arranged closely to its first terminal area according to the present disclosure, according to some embodiments of the present disclosure.

FIG. 15 is a presentation of using just a central portion of the base frame without the primary and secondary beam, when the base frame is combined with a simple crane.

### DETAILED DESCRIPTION

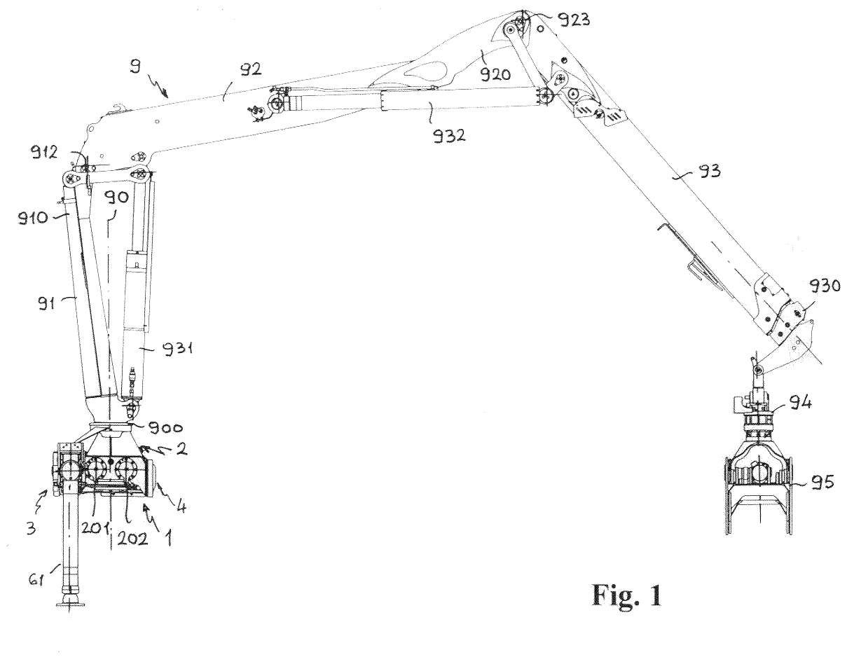

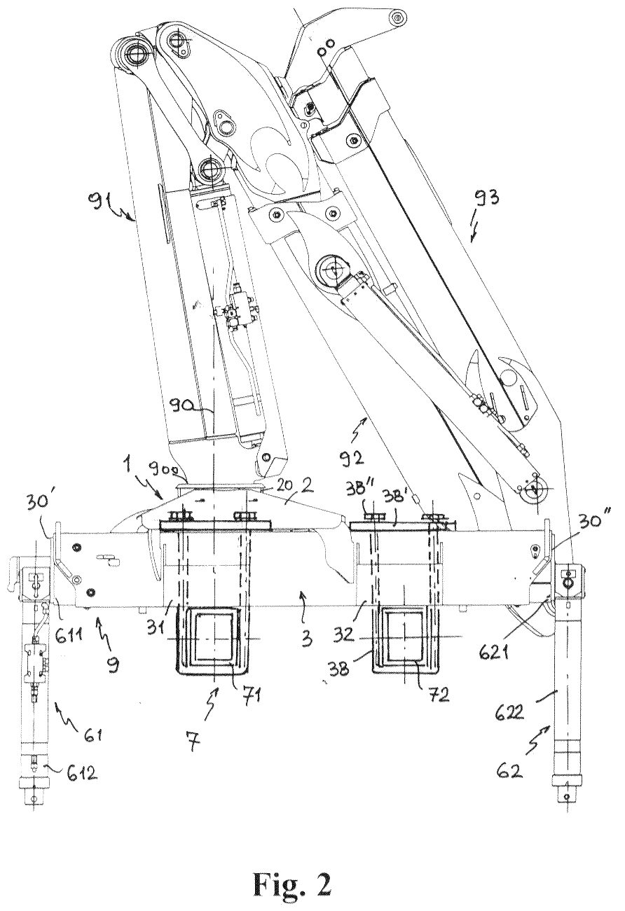

A mobile hydraulic crane 9 (shown in FIGS. 1 and 2) as is known in the prior art, comprises a base frame 1, in which a column 91 of the crane 9 is embedded rotatably around vertical geometric axis 90, and is on said base frame 1 mounted as a cantilever. A primary crane arm 92 is pivotable about a horizontal geometric axis 912 attached to the free terminal area 920 of said column 91, and an optionally telescopic secondary crane arm 93 is pivotable about a horizontal geometric axis 923 attached to the free terminal area 930 of said primary arm 93. A grabber 95 is pivotably, either directly or via a rotation unit 94, attached on a free terminal area of said second arm 93. Said primary arm 92 is supported on said column 91 by means of a hydraulic cylinder 931, which is on the one end pivotably connected to said column 91 and on the other end is also pivotably connected to the primary arm 92. Similarly, the second arm 93 is supported on said primary arm 92 by means of a hydraulic cylinder 932 which is on one end pivotably connected to said primary arm 92 and on the other end also pivotably connected to the secondary arm 93. Said hydraulic cylinders 931, 932 are, together with their associated controlling components and optionally also with said rotating unit 94 and hydraulic components of said grabber 95, integrated into a hydraulic circuit (not shown) of the crane. The hydraulic circuit is optionally hydraulically connected to the hydraulic system on a vehicle (not shown), onto which said crane 9 is mounted.

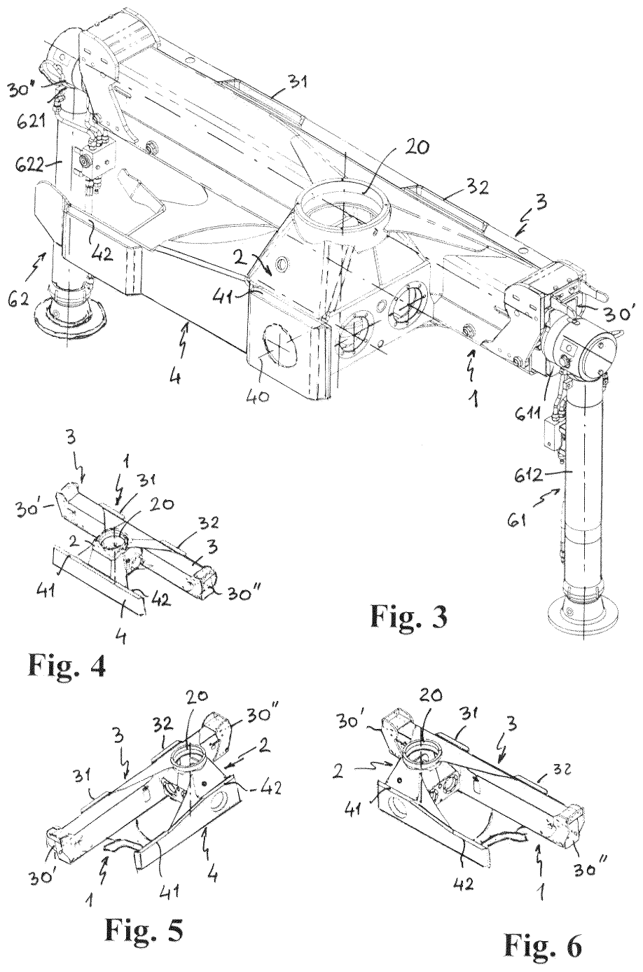

As mentioned above, said column 91 is mounted on such base frame 1 and is rotatable around the vertical geometric axis 90. To this aim, the central portion 2 of the base frame 1 is furnished with a substantially cylindrical central passage 20 (as shown in FIG. 3), which extends along said vertical geometric axis 90 of the column 91. A substantially cylindrical section 900 of the column 91 is inserted into the central passage 20 and at least two bearings that are suitably spaced apart from each other are inserted there-between. Such concept of embedding said column 91 into said base frame 1 on the one hand enables firmly retaining said cantilevered column 91 in place, and on the other hand also a required rotation of the column 91 around said vertical geometric axis 90. For the purpose of rotating the column 91 around said vertical geometric axis 90, said column 91 is either on its circumferential surface, or on its front surface within the central portion 2 of the base frame 1, furnished with a gear (not shown). The gear is rotatable together with the column 91 and is arranged in a horizontal plane so that it is able to cooperate with a pair of gear racks (not shown), which are arranged parallel to each other in said horizontal plane and are displaceable longitudinally in opposite directions with respect to each other. Each of said gear racks is displaceable by means of a hydraulic cylinder 201, 202. The hydraulic cylinders 201, 202 are mounted within the area of said central portion 2 of the base frame 1 and extend parallel to each other, but act simultaneously in opposite direction. To this aim, said central portion 2 of the base frame 1 is furnished with two throughout passages 201′, 202′, which extend parallel to each other and are located in a same horizontal plane so that the piston roads of said cylinders 201, 202 may be inserted therein together with said gear racks, which are foreseen for cooperation with said gear on the column 91.

For the purposes of positioning and connection of said central portion 2 with a vehicle chassis 7, said central portion 2 is on the one side of its cylindrical central passage 20 furnished with a primary beam 3, and on the diametrically opposite side with a secondary beam 4. Said vehicle chassis 7 (shown in FIG. 2), which is suitable for mounting of said crane 9 (at least in the area intended for mounting said crane 9), comprises two bearing beams 71, 72 that are located a certain distance above the ground and extend parallel to each other in the longitudinal direction of the vehicle. The bearing beams may have a cross-section that is I or C or similar profile, or may be tubular, e.g. square or rectangular tubes. Nevertheless, for mounting of the crane 9 thereon it is normally sufficient, if each of said bearing beams 71, 72, on the side facing away from the ground, furnished with a sufficiently extensive smooth and flat surface. These surfaces on the bearing beams 71, 72 should normally also be located within the same plane.

Said primary beam 3, which may also be called a bridge, is generally a sufficiently rigid longitudinal beam that is suitable for resting onto the surfaces facing away from the ground on each of said bearing beams 71, 72, but is simultaneously also tubular. Namely, the tubular primary beam 3, which is transversally oriented on the chassis 7 and is located on the bottom horizontal surface 31′ thereof, is faced towards the ground and is resting onto said bearing beams 71, 72 of the chassis 7. This may allow supporting legs 61, 62 of the crane 9 to be embedded in the primary beam 3. The supporting legs 61, 62 are intended for supporting and stabilizing the crane 9 during its operation. Each of said supporting legs 61, 62 comprises a horizontal beam 611, 621, which is insertable into an associated tubular aperture 30′, 30″ within said primary beam 3 of the base frame 1 and a telescopically extendable vertical hydraulic support 612, 622 that protrudes towards the ground. Horizontal beams 611, 621 of said supporting legs 61, 62 are, during transporting of the crane 9, in a folded state in which the horizontal beams 611, 621 are pushed into the interior of said tubular primary beam 3 of the base frame 1 and are secured against undesired extraction therefrom. Prior to use of the crane 9, said horizontal beams 611, 621 of the supporting legs 61, 62 need to be extracted to a desired extent and then secured against undesired further displacing. Moreover the telescopic vertical supports 612, 622 are extended and are rested onto the ground so that the crane 9 is additionally supported in at least two further points that are located outside of the vertical silhouette of the vehicle. And since the primary beam 3 must also assure a reliable attachment of the crane 9 onto a vehicle chassis 7, it is furnished with at least two attaching seats 31, 32. The two attaching seats 31, 32 are located on the vertical lateral surface 33″ (also referred to as the horizontal lateral surface) of the primary beam, which is faced away from said central portion 2. The attaching seats 31, 32 are each adapted for establishing a reliable screw joint between the base frame 1 and each of said bearing beams 71, 72 of the chassis 7. The term “attaching seat” may mean a properly rigid, stable and correspondingly reinforced location on a beam, which is able to withstand to essential static and dynamic stresses and transfer them onto the beam within a limited local area without the risk of overloading or excessive deformations within the material of the beam as such.

The crane 9 may generally be mounted onto different vehicles. Said attaching seats 31, 32 on the primary beam 3 of the base frame 1 allow mounting of the crane 9 on different vehicles of various manufacturers, and also displacement of a certain crane 9 from one vehicle onto another vehicle, which, in practice, may occur when the vehicle is replaced, e.g. due to damages, wearing or sale of the vehicle or sometimes also of the crane 9. In the shown embodiment (FIG. 2), the primary beam 3 is in the area of each of said attaching seats 31, 32 on the base frame 1 resting on corresponding bearing beams 71, 72 of the vehicle chasses 7. The primary beam 3 is, by means of a C-shaped clamp 38 with a pair of threaded arms, a sufficiently rigid plate 38′ and corresponding nuts 38″ and washers, firmly screwed onto each associated bearing beam 71, 72. Thus, a technically correct interconnection is established between the crane 9 and the vehicle chassis in which the loading performances and stresses can be mathematically determined. Moreover, the interconnection can also be efficiently protected against corrosion and can also be disassembled if needed. Those skilled in the art will, however, no doubt understand that there are also other possibilities of establishing said interconnection between the crane 9 and the vehicle chassis 7.

The secondary beam 4, which is arranged substantially in parallel and diametrically opposite to said primary beam 3 with regard to the central portion 2 of the base frame 1, is intended merely for resting of said base frame 1 onto said bearing beams 71, 72 of the vehicle chassis 7 and simultaneously also for establishing a reliable screw joint between the base frame 1 and at least one bearing beam 71, 72 of said vehicle chassis 7. In combination with said primary beam 2, this should be sufficient for establishing a reliable mutual interconnection between the crane 9 and the vehicle chassis 7. To this aim, the secondary beam 4 is furnished with at least one attaching seat 41, 42 arranged in the area above the corresponding bearing beam 71, 72 of the vehicle chassis 7 that may be interconnected by means of a screw joint. Also, in embodiments using primary and secondary beams, the crane 9 may be mounted on different vehicles of various manufacturers. The screw joint can be established in practically the same way as explained above in relationship to said primary beam 3, namely by means of a threaded clamp, a plate and corresponding nuts.

Various embodiments of secondary beams 4 are known in the art. In a rigid embodiment, the secondary beam 4 is rigidly interconnected with the central portion 2 and is usually furnished with two resting seats 41, 42 that are spaced apart from each other. In a pivotal embodiment of the secondary beam 4, a rigid secondary beam 4 is in its central area, or at any suitable pivot point, pivotably connected to the central portion 2 about a horizontal geometric axis. Such a pivotal secondary beam 4 may have one resting seat 41 or two resting seats 41, 42 that are arranged on both sides of said pivot point and connected to each corresponding bearing beam 71, 72 of the vehicle chassis 7 by means of a suitable screw joint. Thus, during operation of the crane 9, such pivotal secondary beam 4 is allowed to be pivoted in one or another direction and is therefore much more easily adapts to deformations of the vehicle chassis 7 that may occur during operation of the crane 9. This may lead to certain benefits in transferring of dynamic loadings because deformations in each of said bearing beams 71, 72 of the vehicle chassis 7 may arise gradually, less stressful and independently from each other, depending on loading circumstances on the crane 9. Thus, the impact of dynamic stresses may be reduced and interaction between the crane and the vehicle chassis 7 in transferring the loads and accommodating deformations can be improved. Moreover, the risk of damages both on the vehicle and on the crane 9 is then reduced.

Some embodiments of the present disclosure may include a base frame 1 of a mobile hydraulic crane 9, which comprises said central portion 2, said primary beam 3 and said secondary beam 4. Similarly like in several other solutions known from the prior art (FIGS. 1-6) , said central portion 2 is furnished with a cylindrical central passage 20 that is adjusted for receiving a cylindrical section 900 on the crane 9 and the central geometric axis 90 of which extends in a vertical direction. Moreover, the central portion 2 may include two through passages 201′, 202′ spaced apart from each other that extend in a vertical plane and are adapted for receiving said hydraulic cylinders 201, 202 with belonging piston roads and gear racks suitable for cooperation with a gear. The hydraulic cylinders 201, 202 allow the column 91 of said crane (9) to rotate within the central passage 20. Similar to solutions known in the art, said tubular primary beam 3 is arranged on one side of said central portion 2 and extends substantially parallel to said through passages 201′, 202′ within the central portion 2. The primary beam 3 is, on its terminal portions, furnished with apertures 30′, 30″ that are suitable for receiving supporting legs 61, 62. Moreover, the primary beam 3 is furnished with a horizontal bottom surface 33′, which is suitable for resting on bearing beams 71, 72 of a vehicle chassis 7, to which in the area of said base frame 1 the crane 9 is mountable. In addition to that, said primary beam 3 comprises at least two attaching seats 31, 32 located on its vertical lateral surface 33″ that faces away from said central portion 2. The at least two attaching seats 31, 32 are arranged in pre-determined areas where the primary beam 3 is intended to be rest onto said bearing beams 71, 72 of a vehicle chassis 7. Similar to solutions known in the art, said secondary beam 4 is arranged on the opposite side of the central portion 2 from said primary beam 3 and relative to said throughout passages 201′, 202′ such that said hydraulic cylinders 201, 202 can be placed within the central portion 2. The secondary beam 4 comprises a horizontal bottom surface 44′ suitable for resting on bearing beams 71, 72 of a vehicle chassis 7, to which in the area of said base frame 1 the crane 9 is mountable. Moreover, said secondary beam 4 comprises at least one attaching seat 41, 42 located on its vertical lateral surface 44″ that faces away from said central portion 2. The at least one attaching seat 41, 42 is arranged in a pre-determined area where the secondary beam 4 is intended to rest onto at least one of said bearing beams 71, 72 of a vehicle chassis 7.

However, in order to solve the technical problem described above, said central portion 2 of the base frame 1 is an independent uniform part that is furnished with said cylindrical passage 20 for receiving of a column 91 of the crane 9 and with said horizontal passages 201′, 201″ for receiving of hydraulic cylinders 201, 202 for controlled rotation of the column 91 around the vertical geometric axis 90. Besides, the present disclosure also provides that said primary beam 3 is an independent and uniform tubular part that is, on its terminal areas, furnished with apertures for receiving supporting legs 61, 62 and with a horizontal bottom surface 33′ that is suitable for being rest on bearing beams 71, 72 of the vehicle chassis 7. The primary beam 3 also includes at least two attaching seats 31, 32 arranged on its vertical surface 33″ at pre-determined locations corresponding to said bearing members 71, 72 of the vehicle chassis 7. And still further, the present disclosure also provides that said secondary beam 4 is an independent and uniform part, that is furnished with a horizontal bottom surface 44″ suitable for resting on said bearing members 71, 72 of the vehicle chassis 7. The secondary beam 4 also includes at least one attaching seat 41, 42 arranged on its vertical lateral surface 44″ that faces away from said central portion 2 and arranged at pre-determined location(s) corresponding to said bearing members 71, 72 of the vehicle chassis 7. The present disclosure further proposes that said central portion 2 of the base frame 1 is in the area outside of the circumference of said cylindrical central passage 20, which extends along said central geometric axis 90, and also outside of the area of said through passages 201′, 202′, namely on the one side of said passages 201′, 202′. The central portion 2 is form-locking assembled with said primary beam 3 by means of a screw joint 23 such that it is firmly but detachably connectable with said primary beam 3. The primary beam 3 is oriented in such manner that its vertical surface 33″ with said attaching seats 31, 32 is faced away from the central portion 2. The present disclosure still further proposes that, on the opposite side of said through passages 202′, 202′, said central portion 2 is form-locking assembled also with said secondary beam 4 by means of a screw joint 24 such that it is firmly but detachably connectable with said secondary beam 4. The primary beam 3 and secondary beam 4 are arranged parallel to each other and in such a way that their bottom surfaces 33′, 44′ are located substantially within the same plane. Details related to said form-locking assembling and detachable connection of the central portion 2 on one end with the primary beam 3 and on the other end with the secondary beam 4 will be explained below.

In some embodiments of the present disclosure in which said secondary beam 4 is generally form-locking assembled with said central portion 2 by means of a screw joint 24 such that it is firmly but detachably connectable there-with, the secondary beam 4 is also pivotable about a horizontal axis 40 that extends perpendicularly with respect to each geometric axis of each through passage 201′, 202′ in the central portion 2. In some embodiments in which said secondary beam 4 is on one side firmly connected with the central portion 2 and on the other side with the chassis 7, preferably just one of the bearing beams 71, 72 of the chassis 7 should be connected with the secondary beam 4 by means of just one attaching seat 41 on just one of its arms on the one side of its pivot point, while its other arm on the opposite side of said pivot point is simply rest onto the other bearing beam 71, 72 of the chassis 7, but is not connected therewith.

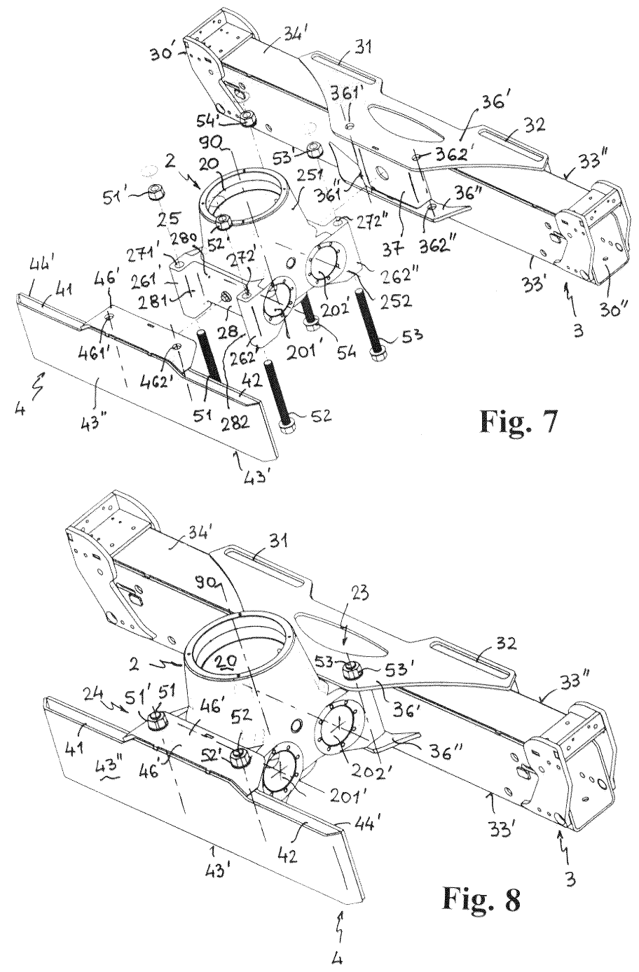

In some embodiments in which there is a form-locking interconnection of the central portion 2 and the primary beam 3, the present disclosure (shown in FIGS. 7 and 8) that said central portion 2 should comprise a substantially tubular area 251, which extends in vertical direction and within which said central passage 20 and a base area 252 through which said through passages 201′, 202′ extend parallel to each other are formed. Said base area 252 is on each side, with respect to said through passages 201′, 202′, furnished with two pairs of protrusions 261′, 262′; 261″, 262″ that are spaced apart from each other and that extend in a horizontal direction away from said through passages 201′, 202′ and substantially perpendicularly with respect to them. Each of said protrusions 261′, 262′; 261″, 262″ is furnished with a vertical throughout bore 271, 272′; 271″, 272″ and all protrusions 261′, 262′; 261″, 262″ have the same height, namely along their vertical dimension in the geometric axis 90. In a preferred embodiment of the present disclosure, said through bores 271, 272′; 271″, 272″ are arranged symmetrically with regard to said longitudinal geometric axis 90 of said central passage 20 and in corners of a virtual square with its sides arranged parallel and perpendicular to said through passages 201′, 202′. In addition to that, in the area between each pair of protrusions 261′, 262′; 261″, 262″, indentations 28, 28′ are formed by two flat and vertical inner surfaces 281, 282 of two neighboring protrusions 261′, 262′; 261″, 262″ that face towards one another on the same side of said through passages 201′, 202′ and by a vertical intermediate surface 280 on said base area 252 of the central portion 2, to which said inner surfaces 281, 282 of the corresponding protrusions 261′, 262′; 261″, 262″ are perpendicular.

On the other side, said primary beam 3 is, in the area between said attaching seats 31, 32 on its bottom horizontal surface 33′, furnished with a flat attaching tongue 36″ and, on its top horizontal surface 34′, furnished with a further flat attaching tongue 36′. Said attaching tongues 36′, 36″ each extend in a horizontal direction away from said attaching seats 31, 32. Moreover, said attaching tongues 36′, 36″ extend substantially parallel to each other and are spaced apart from each other at a distance corresponding to said height, i.e. said vertical dimension, of said protrusions 261′, 262′; 261″, 262″ on the central portion 2. Still further, each one of said attaching tongues 36′, 36″ is furnished with two through bores 361′, 362′: 361″, 362″, which are spaced apart from each other in such a way that the bores 361′, 362′ on the one attaching tongue 36′ are arranged coaxially with the bores 361″, 362″ on the other attaching tongue 36″ and that the distance between them corresponds to the distance between the through bores 271′, 272′; 271″, 272″ on the said protrusions 261′, 262′; 261″, 262″ on the central portion 2 on the same side of said throughout passages 201′, 202′. A protrusion 37 is formed in the area between said attaching tongues 36′, 36″ such that it away from said attaching seats 31, 32 and is positively and tightly insertable into one of said indentations 28, 28′ between two neighboring protrusions 261′, 262′; 261″, 262″ of the base area 252 on the same side with respect to said through passages 201′, 202′.

Similarly, the secondary beam 4 is, on its bottom horizontal surface 43′, furnished with a flat attaching tongue 46′ and, on its top horizontal surface 44′, furnished with a flat attaching tongue 46″. Said attaching tongues 46′, 46″ are both directed in a horizontal direction away from said attaching seats 31, 32. Moreover, said attaching tongues 46′, 46″ are both oriented in the same direction and extend substantially parallel to each other and are spaced apart from each other at a distance corresponding to said height, i.e. said vertical dimension, of said protrusions 261′, 262′; 261″, 262″ on the central portion 2. Each of said attaching tongues 46′, 46″ is furnished with two through bores 461′, 462′; 461″, 462″, which are spaced apart from each other in such a way that the bores 461′, 462′ on the one attaching tongue 46′ are arranged coaxially with the bores 461″, 462″ on the other attaching tongue 46″ and that the distance between them corresponds to a distance between the throughout bores 271, 272′; 271″, 272″ on the said protrusions 261′, 262′; 261″, 262″ on the central portion 2 on the same side of said throughout passages 201′, 202′. Again, a protrusion 47″ is formed between said attaching tongues 46′, 46″ such that it is positively and tightly insertable into one of said indentations 28, 28′ between two neighboring protrusions 261′, 262′; 261″, 262″ of the base area 252 on the same side with respect to said through passages 201′, 202′.

As soon as the primary beam 3 is by means of its protrusion 37 inserted into said indentation 28, 28′ on the one side of the central portion 2 and the secondary beam 4 is by means of its protrusion 47″ inserted into a corresponding indentation 28, 28′ on the opposite side of the central portion 2, said form-locking interconnection of the central portion 2 with the primary beam 3 and the secondary beam 4 is established. This interconnection is additionally fixed by means of said screw joints 23, 24. Establishment of said form-locking interconnection is crucial for achieving a required rigidity of such assembled base frame 1, such as that found in base frames known from the prior art.

In an alternative embodiment of the base frame 1 with a pivotal secondary beam 4, said secondary beam 4 comprises an attaching portion 410 and a resting portion 420. The attaching portion 410 comprises, on one side, said attaching tongues 46′, 46″ and said protrusion 47″ and, on the other side, also a pivot pin 47. The pivot pin 47 is arranged on a vertical surface 41′ of said attaching portion 410 in the area between said attaching tongues 46′, 46″ and protrudes in a direction opposite to said attaching tongues 46′, 46″. The resting portion 420 of the secondary beam 4 is furnished with a through bore 47′ that is placeable onto said pivot pin 47 to pivotably connect to said attaching portion 410. Said at least one attaching seat 41, 42 on the vertical lateral surface 44′ and a bottom surface 43′, which are adapted for placement onto at least one of the bearing members 71, 72 of a vehicle chassis 7, are arranged on the resting portion 420 of the secondary beam 4.

Said screw joint 23 between the central portion 2 and the primary beam 3 is formed by the protrusion 37 of the primary beam 3 being inserted into said indentation 28 on the base area 252 of the central portion 2 such that two protrusions 261′, 262′; 261″, 262″ on said base area 252 of the central portion 2 are located between the top and the bottom attaching tongue 36′, 36″ of the primary beam 3. Screws 51, 52 are inserted through said vertical through bores 271′, 272′ on protrusions 261′, 262′ on the same side of said through passages 201′, 202′ and simultaneously also through said bores 361′, 362′; 361″, 362″ in said attaching tongues 36′, 36″. The screws 51, 52 are secured to the through bores 271′, 272′ and through passages 201′, 202′ via corresponding nuts 51′, 52′ and washers.

Similarly, the screw joint 24 between the central portion 2 and the secondary beam 4 is formed by the protrusion 47″ being inserted into said indentation 28′ on the base area 252 of the central portion 2 such that two protrusions 261′, 262′; 261″, 262″ on said base area 252 of the central portion 2 are located between the top and the bottom attaching tongue 46′, 46″ of the secondary beam 4. Screws 53, 54 are inserted through said vertical through bores 271″, 272″ on protrusions 261″, 262″ on the same side of said through passages 201′, 202′ and simultaneously also through said bores 461′, 462′; 461″, 462″ in said attaching tongues 36′, 36″. The screws 53, 54 are secured to the through bores 271″, 272″ and the through passages 201′, 202′ via corresponding nuts 53′, 54′ and washers.

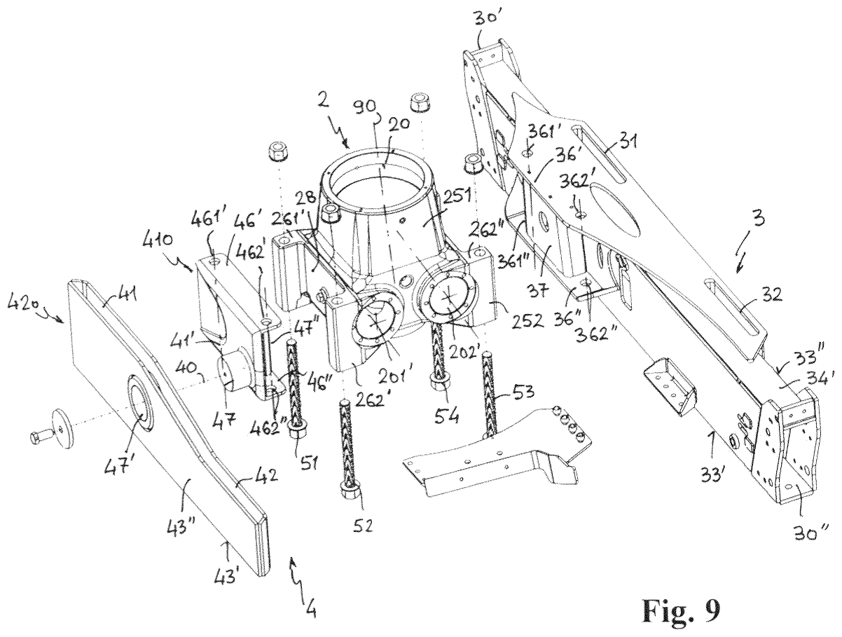

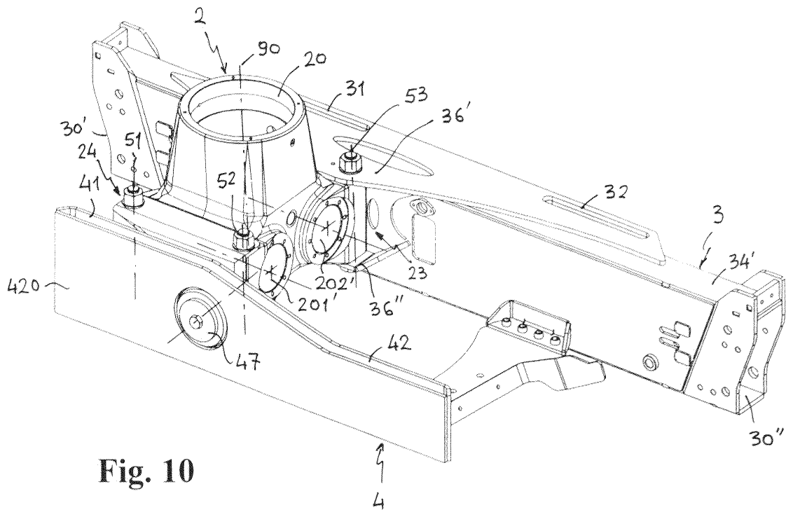

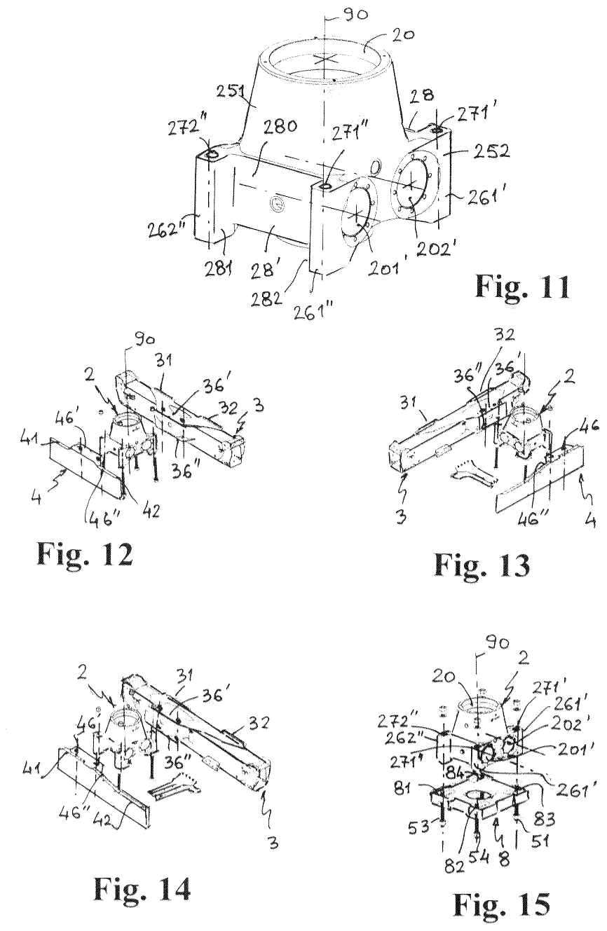

When observed in longitudinal direction of the primary beam 3, said attaching tongues 36′, 36″ are arranged either in the central area of the primary beam 3 (as shown in FIG. 12), or outside of the central area of the primary beam 3 (as shown in FIGS. 13 and 14). In the art, selection among these possibilities may determine a position of the central portion 2 relatively to the primary beam 3 and the bearing beams 71, 72 of the vehicle chassis 7. Therefore, a same, single central portion 2 can be combined with anyone of different primary beams 3 according to FIGS. 12-14 and also with anyone of different secondary beams 4 according to FIG. 7-8 or 9-10 .

The present disclosure further provides that said primary beam 3 is a uniform part that is formed of metallic semi-products being welded together. In particular, components are initially each separately cutout from a metallic plate and properly shaped before being welded together. It is also foreseen that a rigid secondary beam 4 the resting portion 420 of a pivotal secondary beam 4 is a uniform part that is formed of metallic semi-products that are welded together. In particular, components are initially separately cutout from a metallic plate and properly shaped before being welded together. Moreover, said central portion 2 is a uniform part that is formed of metallic semi-products that are welded together. In particular, at least one tubular metallic component and other components are initially separately cutout from a metallic plate and properly shaped before being welded together and also with said tubular metallic components. But alternatively, in accordance with teachings according to the present disclosure, said central portion 2 may also be a mechanically machined part consisting of cast metal, or a mechanically machined part that is pre-formed by forging.

As one can learn from the previous description, manufacturing of each one of such independent components of the base frame 1, namely of the central portion 2, the primary beam 3 and the secondary beam 3, may be less complicated than manufacturing of a huge and complex base frame 1 as known from the prior art. As previously described, the possibility of combining different versions of the primary beam 3 and/or the secondary beam 4 with a single version of the central portion 2 may further contribute in achieving a synergy, which leads to avoiding numerous serious problems and also to essential improvements of economic yields.

As known, simplified cranes with lower capacities are also used in the art, and can be mounted either onto a vehicle, or also onto a trailer, like e.g. a tractor trailer. In these circumstances, said central portion 2 is applicable as such and without the need to combine it with said primary beam 3 and said secondary beam 4. To this aim, the central portion 2 is, in the area of its vertical throughout bores 271′, 272′; 271″, 272″, connectable to a rigid bearing plate 8 by means of screws 51, 52, 53, 54 in a detachable manner. The bearing plate 8 is furnished with through bores 81, 82, 83, 84, which are arranged to correspond to said vertical through bores 271′, 272′; 271″, 272″ on the central portion 2 and are arranged to coaxially align with the through bores 271′, 272′; 271″, 272″ when the central portion 2 and said plate 8 are assembled. And as mentioned, said bearing plate 8 is an integral part of a motor vehicle chassis 7 or a trailer.

What is claimed is:

1. A base frame of a mobile hydraulic crane, comprising:
a central portion having a cylindrical central passage that is configured to receive a cylindrical section of the crane, wherein a central geometric axis of the central portion extends in a vertical direction, wherein the central portion comprises two through passages that are spaced apart from each other and extend in a vertical plane, wherein the through passages are configured to receive hydraulic cylinders having piston roads and gear racks suitable for cooperation with a gear, wherein the hydraulic cylinders are configured to rotate the column of said crane within said central passage;
a tubular primary beam arranged on a first side of said central portion and extending substantially parallel to said through passages disposed within the central portion, wherein the primary beam comprises:
terminal portions comprising apertures that are configured to receive supporting legs;
a horizontal bottom surface that is configured to rest on bearing beams of a vehicle chassis, wherein an area of said base frame of the crane is mountable to the bearing beams;
at least two attaching seats located on a vertical lateral surface of the primary beam, wherein the vertical lateral surface of the primary beam is faced away from said central portion, and wherein the at least two attaching seats are arranged in pre-determined areas that the primary beam is intended to be rest onto said bearing beams of said vehicle chassis;
a secondary beam arranged on an opposite side of the central portion from said primary beam and comprising:
a horizontal bottom surface configured to rest on the bearing beams of the vehicle chassis to which the area of said base frame of the crane is mountable;
at least one attaching seat located on the vertical lateral surface of the secondary beam, wherein the vertical lateral surface of the secondary beam is faced away from said central portion and arranged in a pre-determined area in which the secondary beam is planned to be rest onto at least one of said bearing beams of the vehicle chassis
wherein said central portion of the base frame is an independent uniform part,
wherein said primary beam is an independent and uniform tubular part
wherein said secondary beam is an independent and uniform part, and
wherein said central portion of the base frame is disposed outside of a circumference of said cylindrical central passage and outside of said through passages wherein the central portion is disposed on one side of said through passages wherein said central portion is form-locking assembled with said primary beam by a screw joint (23) that firmly but detachably connects the central portion with said primary beam, wherein the primary beam is oriented with the vertical surface with said attaching seats faced away from the central portion, wherein, on an opposite side of said through passages, said central portion is form-locking assembled with said secondary beam by a screw joint that firmly but detachably connects the central portion with said secondary beam, wherein said primary beam and said secondary beam are arranged parallel to each other and with the bottom surfaces of the primary beam and the secondary beam located substantially within the same plane.

2. The base frame according to claim 1, wherein said secondary beam pivotable about a horizontal axis that extends perpendicularly with respect to each geometric axis of each through passage in the central portion.

3. The base frame according to claim 1, wherein said central portion further comprises a substantially tubular area protruding in a vertical direction and comprising said central passage and a base area through which said through passages extend parallel to each other, wherein said base area comprises two pairs of protrusions that are spaced apart from each other on each side of said through passages, wherein the two pairs of protrusions extend in a horizontal direction away from said through passages and substantially perpendicularly with respect to said through passages, wherein each of said protrusions comprises a vertical throughout bore and wherein each protrusion comprises an equal height in the vertical dimension along the vertical geometric axis.

4. The base frame according to claim 3, wherein said through bores are arranged symmetrically with respect to said vertical geometric axis of said central passage, wherein the through bores are located in corners of a virtual square formed such that sides of the virtual square are arranged parallel or perpendicular with respect to said through passages

5. The base frame according to claim 3, wherein an indentation is located in an area between each pair of protrusions, wherein each indentation is formed by:
two flat vertical inner surfaces of two neighboring protrusions on the same side of said through passages that face towards each other; and
a vertical intermediate surface on said base area of the central portion (2), to which said inner surfaces (281, 282) of the corresponding protrusions (261′, 262′; 261″, 262″) are perpendicular.

6. The base frame according to claim 3, wherein said primary beam comprises a flat attaching tongue located in an area between said attaching seats on a bottom horizontal surface of the primary beam and further flat attaching tongue located on a top horizontal surface between said attaching seats, wherein said attaching tongues each extend in a horizontal direction away from said attaching seats, wherein said attaching tongues extend substantially parallel to each other and are spaced apart from each other at a distance corresponding to said height of said protrusions on the central portion, and wherein each of said attaching tongues comprises two through bores spaced apart from each other such that the bores on the attaching tongue are arranged coaxially with the bores on the further attaching tongue, wherein a distance between the bores of the attaching tongues corresponds to a distance between the through bores on said protrusions on the central portion on the same side of said through passages.

7. The base frame according to claim 6, wherein a protrusion is formed between said attaching tongues such that it faces away from said attaching seats, wherein the protrusion is positively and tightly insertable into one of said indentations between two neighboring protrusions of the base area on the same side with respect to said through passages.

8. The base frame according to claim 7, wherein said secondary beam comprises a flat attaching tongue located on a bottom horizontal surface and a further flat attaching tongue located on a top horizontal surface wherein said attaching tongues are both directed away from said attaching seats in a horizontal direction , and wherein said attaching tongues are both oriented in the same direction and extend substantially parallel with each other and are spaced apart from each other at a distance corresponding to said height of said protrusions on the central portion, and wherein each of said attaching tongues comprises two through bores spaced apart from each other such that the bores on the attaching tongue are arranged coaxially with the bores on the further attaching tongue, wherein the distance between them corresponds to a distance between the through bores on said protrusions on the central portion on the same side of said through passages.

9. The base frame according to claim 8, wherein a protrusion is formed between said attaching tongues wherein the protrusion is positively and tightly insertable into one of said indentations between two neighboring protrusions of the base area on the same side with respect to said through passages.

10. The base frame according to claim 2, wherein said secondary beam comprises:
an attaching portion comprising said attaching tongues and said protrusion of the secondary beam on a first side of said secondary beam and a pivot pin disposed on a vertical surface of said attaching portion in an area between said attaching tongues on a second, opposite side of said secondary beam and protrudes in a direction opposite from said attaching tongues; and
a resting portion comprising a through bore located such that it is attachable to said pivot pin such that it is pivotably connected to said attaching portion and at least one attaching seat on each of a vertical lateral surface and a bottom surface, wherein the at least one attaching seats are configured to be placed on at least one bearing member of a vehicle chassis.

11. The base frame according to claim 9, wherein said screw joint between the central portion and the primary beam is formed such that:
the protrusion of the primary beam is inserted into said indentation on the base area of the central portion,
two protrusions on said base area of the central portion are located between the top and the bottom attaching tongues of the primary beam (3),
screws are inserted through said vertical throughout bores on protrusions on the same side of said through passages and simultaneously through said bores in said attaching tongues, and
nuts and washers corresponding to the screws are coupled thereto.

12. The base frame according to claim 9, wherein said screw joint between the central portion and the secondary beam is formed such that:
the protrusion of the secondary beam is inserted into said indentation on the base area of the central portion,
the two protrusions on said base area of the central portion are located between the top and the bottom attaching tongues of the secondary beam,
screws (53, 54) are inserted through said vertical throughout bores on the protrusions on the same side of said through passages and simultaneously through said bores in said attaching tongues, and
nuts and washers corresponding to the screws are coupled thereto.

13. The base frame according to claim 9, wherein said attaching tongues are arranged in a central area of the primary beam.

14. The base frame according to claim 9, wherein said attaching tongues are arranged outside of a central area of the primary beam.

15. The base frame according to claim 1, wherein said primary beam is a uniform part that is formed components that are separately cutout from a metallic plate and shaped before being welded together.

16. The base frame according to claim 10, wherein said resting portion of the secondary beam is a uniform part that is formed of components that are separately cutout from a metallic plate and properly shaped before being welded together.

17. The base frame according to claim 1, wherein said central portion is a uniform part that is formed of at least one tubular metallic component and other components that are separately cutout from a metallic plate and properly shaped before being welded together.

18. The base frame according to claim 1, wherein said central portion is a mechanically machined part comprising cast metal.

19. The base frame according to claim 1, wherein said central portion is a mechanically machined part that is pre-formed by forging.

20. The base frame according to claim 3, wherein said central portion is connectable via the vertical throughout bores to a rigid bearing plate by screws in a detachable manner wherein the bearing plate comprises through bores, wherein the through bores of the bearing plate are arranged to correspond to and are coaxially aligned with said vertical through bores on the central portion when the central portion and said bearing plate are assembled.

21. The base frame according to claim 20, wherein said bearing plate is an integral part of a motor vehicle chassis.

22. The base frame according to claim 20, wherein said bearing plate is an integral part of a trailer.
